(19) United States
(12) Patent Application Publication
(10) Pub. No.: US 2020/0258073 A1
(43) Pub. Date: Aug. 13, 2020

(54) METHOD AND APPARATUS FOR TRANSMITTING TRANSACTION DATA USING A PUBLIC DATA NETWORK

(71) Applicant: Rubean AG, Munchen (DE)

(72) Inventor: Hermann GEUPEL, Munich (DE)

(21) Appl. No.: 16/791,458

(22) Filed: Feb. 14, 2020

Related U.S. Application Data
(63) Continuation of application No. 15/934,376, filed on Mar. 23, 2018, now abandoned.

(30) Foreign Application Priority Data
Mar. 23, 2017 (DE) 102017106295.5
Sep. 29, 2017 (DE) 102017122799.7

(51) Int. Cl. G06Q 20/32; G06Q 20/40; G06Q 20/10

(52) U.S. Cl. CPC G06Q 20/325; G06Q 20/4012; G06Q 20/40; G06Q 20/3223; G06Q 20/105; G06Q 20/3226

(57) ABSTRACT

A method for transmitting transaction data using a mobile network or WLAN comprising the steps:
a) providing a transaction file on a user terminal in the mobile network or WLAN,
b) requesting an authorization data set, in particular a PIN, of a debit or credit card configured as a smart card and equipped with means for wireless close-range data transmission from an online banking server,
c) transmitting the authorization data set from the online banking server to the user terminal, the user terminal receiving same, and
d1) transmitting the authorization data set from the user terminal to the smart card wirelessly connected to same via close-range data transmission, or
d2) internally transferring the authorization data set to the smart card component in the user terminal,
e) checking the authorization data set by means of a processor of the smart card or smart card component based on comparison data stored thereon and, if correct, outputting a correctness confirmation message to the user terminal or internally within the user terminal, and more.

The invention relates to a method and an arrangement for transmitting transaction data using a public data network. In essence, it relates to a method and system for authorizing online payments.

Online shops today often have several methods of authentication from among which to choose when authorizing an online payment:
prepayment, instant bank transfer or PIN and TAN-based online banking methods, in which the customer has to be ready with his online banking PIN and provide the TAN
ApplePay and Selfie-Pay http://www.welt.de/finanzen/verbraucher/article152595657/Mastercard-Kunden-koennen-bald-per-Selfie-bezahlen.html) biometric methods, which can result in false rejections
PayPal, not as technically secure of a method which only verifies a password.

In unpublished European patent application No. 16204208.9, the applicant proposes a user-friendly and yet ultra-secure method and system of the cited type which functions reliably with high-quality mobile devices.

A suitable smartphone therein assumes the function of a debit/credit card point-of-sale terminal capable of wireless short-range data transmission (NFC). With respect to meeting the standard security requirements for payment transactions, of importance are the security features of the respective user terminal as implemented by the manufacturer.

The present invention addresses the object of disclosing a further user-friendly and yet concurrently secure method and system for authorizing online payments which can be implemented using mid-range and low-priced terminals and thus be accessible to a wider audience.

As far as the method aspect, this object is solved by a method having the features of claim 1 and as far as the apparatus aspect, by an arrangement having the features of claim 10. Advantageous further developments of the inventive concept constitute the subject matter of the respective dependent claims.

The present invention thereby creates a secure and user-friendly method and system for authorizing an online transaction using an NFC-enabled smart card and a simple smartphone.

The invention solves the object as posed in particular by the fact that the card PIN, which is required for EMV-compliant activation of the debit/credit card (card) signature function, is not input via a user interface of the user terminal (smartphone), which would require protective measures against PIN phishing, but is instead automatically sent to the card from a server secured end-to-end (from the server to the card) via the user terminal.

For data protection reasons, the server, which according to the invention must at least occasionally provide the card PIN in plain text, needs to remain at the card's issuing bank. When the NFC-enabled smart card and smartphone need to communicate with the card-issuing bank for the given reason, it is particularly suitable for an online payment to be made via transfer, e.g. subject to the FinTS (formerly known as HBCI) or MasterCard CAP standards, and not subject to a payment transaction standard such as for example ec-Cash.

Used in online banking, the inventive method replaces the TAN (international: one-time code) by a signature on the card which until now could only be activated via special contact-based card readers (Secoder) and not via a commercially available smartphone.

Alternatively to a card PIN as an authorization data set, which the server communicates to the card to activate the signature function, the authorization data set can also consist of other useful data (payload) which is or is to be associated with a verification of originating from an authorized source.

The server can either encrypt the payload to this end with a symmetric key, which is also stored in the card, or sign with an asymmetric public key, the complementary public key to which is stored in the card.

The authorization data set can for example consist of the transaction file which is to ultimately sign the card.

The user terminal can communicate the authorization data set to the server together with previously collected user authentication data, for example a PIN arranged between user terminal and server or the result of a fingerprint comparison, protected by a TLS channel authenticated on both sides. After the server verifies the user authentication data with a positive result, it transmits the authorization data set, e.g. the transaction file, to the card signed or respectively encrypted end-to-end via the user terminal. By linking NFC-enabled debit and credit cards to a customer's NFC-enabled terminal (smartphone), the inventive method and system achieves the following advantages:
It realizes a simple method for activating a signature function on bank cards for authorizing money transfers. The customer only has to hold his NFC-enabled bank card to the smartphone in order to enable money transfers. Within the framework of the new European PSD2 payment service directive, this verification of possession of one's own bank card represents a first of two required authentication factors. Where applicable, a biometric authentication feature (e.g. “fingerprint” or retinal structure) lends itself to being the second factor.
It is secure and cost-effective: By virtue of a secure mobile app installation process and the protected provision of the PIN or other authorization data set, the customer can incorporate his NFC-enabled bank card into online processes such as electronic banking or online/mobile shopping as a security factor using his own, not necessarily sophisticated smartphone.
It largely eliminates PIN phishing at user terminals not equipped with a so-called trusted user interface and in principle supports all devices which allow mobile app access to an integrated NFC interface.

In one possible application, the user's main bank issues the user an NFC-enabled card, expands a pre-existing mobile banking app with the inventive functions of the mobile app, and operates an online banking server. In this case, all three essential communication elements (card, app and server data set) are already logically connected so that the user no longer has to manually assign them.

The main bank could provide its customer with a private key and public key protected pursuant to the white-box cryptography principle for trustworthy communication with the online banking server and an NFC and EMV compatible communication interface to the NFC card during a mobile banking app upgrade.

This arrangement enables using a suitable signature function on the NFC-enabled card in line with the German FinTS standard or other electronic banking standards for the user to confirm a money transfer to the server.

The input of a static password or preferably a finger being placed on a fingerprint sensor on the user's smartphone or other biometric authentication methods could serve as the second authentication factor.

From the user's perspective, enabling a transfer can ensue as follows:

1. In an online banking situation using a desktop computer, the transaction data is loaded onto the smartphone by scanning a QR code or by Google or Apple Push Notification. In a mobile banking situation, this step is omitted.

2. The transfer data is checked on the smartphone screen.

3. The NFC card is held up to the NFC-interface of the smartphone, and

4. A finger is pressed onto the smartphone's fingerprint sensor.

The order of steps 3 and 4 can be switched, particularly when the transaction file, before being signed on the card, is communicated to the server together with the user authentication data so that an authorization data set can be created from the transaction file which activates the card for the signature of the transaction file.

The user authentication data expresses the intent (act of will) of the user wishing to make the transaction.

There are different ways in which the transaction file can be provided in step a) of the proposed method. In a first, so to speak “direct” alternative, this step comprises the following sub-steps:

a0′) transmitting initial transaction data from a web server to the user terminal via the data network and mobile network or WLAN and generating an initial transaction file in the user terminal,

a1′) processing the initial transaction file on the user terminal so as to extract at least some of the transaction data.

In another alternative, in which the user uses a further device (for instance a laptop or tablet) in addition to his smartphone, step a) comprises for example the following sub-steps:

a0) transmitting initial transaction data from a web server to a display unit connected to the data network via said data network, and

a01) local visual and/or acoustic displaying of the initial transaction data thereon, particularly visually displaying as bar code or QR code on a provider website, or

a02) forwarding the initial transaction data via Google or Apple Push Notification service to the user terminal,

a11) receiving the display and generating an initial transaction file in the user terminal or

a12) receiving the display and generating an initial transaction file in a receiver device and thereafter transmitting same to the user terminal via wireless close-range data transmission,

a2) processing the initial transaction file on the user terminal to extract at least some of the transaction data.

In one preferred implementation from the current perspective, a mobile app installed in the user terminal authorizes the authorization data service to the online banking server in step b) by means of a private key, which is in particular fragmented pursuant to the white-box cryptography principle and stored in distributed fashion by the program code of the mobile app. This reduces the chances of phishing attack success to almost zero.

It appears further preferential for the mobile app to be uniquely assigned an NFC card of wireless close-range data transmission during installation on the user terminal and this assignment to be stored in the online banking server of the authorization data service. This further increases the security of the entire process insofar as virtually eliminating fraudulent interference at the connection point between the NFC card and the mobile app.

With the same objective of further increasing security, a further implementation provides for the mobile app being authenticated to the online banking server by a public key procedure and/or the mobile app and online banking server communication being subject to encryption. According to a further implementation of the invention, a user biometric authentication step is additionally carried out on the user terminal, in particular via a fingerprint sensor. Although this implementation does require the user terminal to have a sensor for biometric user characteristics, it then provides an easily realizable further security advantage.

For the essential data exchange between user terminal and smart card, one advantageous implementation is in which the user terminal and the smart card communicate bi-directionally via the near-field communication (NFC) protocol and the EMV standard for chip-based payment cards.

It is furthermore provided for the authorization data set to in practice comprise the encrypted transaction file or a PIN of the credit card or debit card such as for example the Girocard (bank card) in step c. Alternatively, a data set of physiological user data (fingerprint, retinal image, voice profile, etc.) can in principle also be used, although it carries a higher latent risk of rejection for the desired transaction.

Device and/or system aspects of the present invention largely ensue from the method aspects described above and will insofar not be repeated at this point. It is noted that configurations which make use of a smart card separate from the user terminal or a smart card component incorporated into the user terminal are also included herein.

However, it is also pointed out that in one expedient implementation the user terminal has a device key to authenticate in particular a private key in terms of a public key infrastructure (PKI), at least with respect to an app loading system and with respect to the online banking server of the authorization data service.

In a further advantageous implementation of the user terminal, the user terminal comprises a biometric sensor for detecting a user's biometric data, in particular a fingerprint sensor, and the mobile app for processing a biometric data set is formed by a biometric sensor.

Advantages and functionalities of the invention are additionally yielded by the following description of an example embodiment and from design aspects of the invention based on the figures, which show:

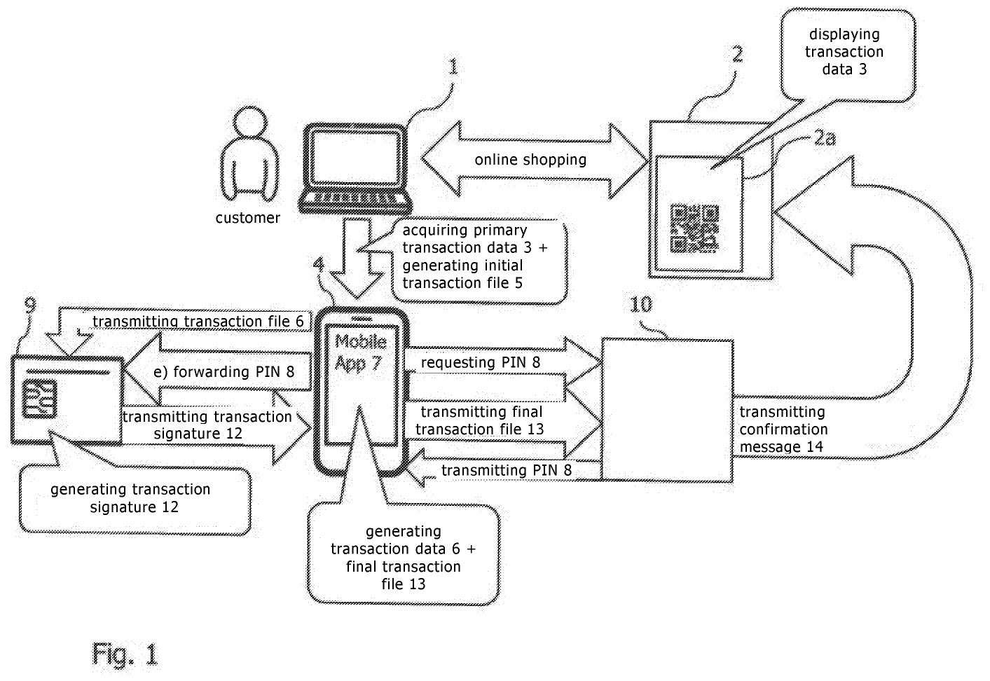

FIG. 1 a schematic depiction of an arrangement according to the invention,

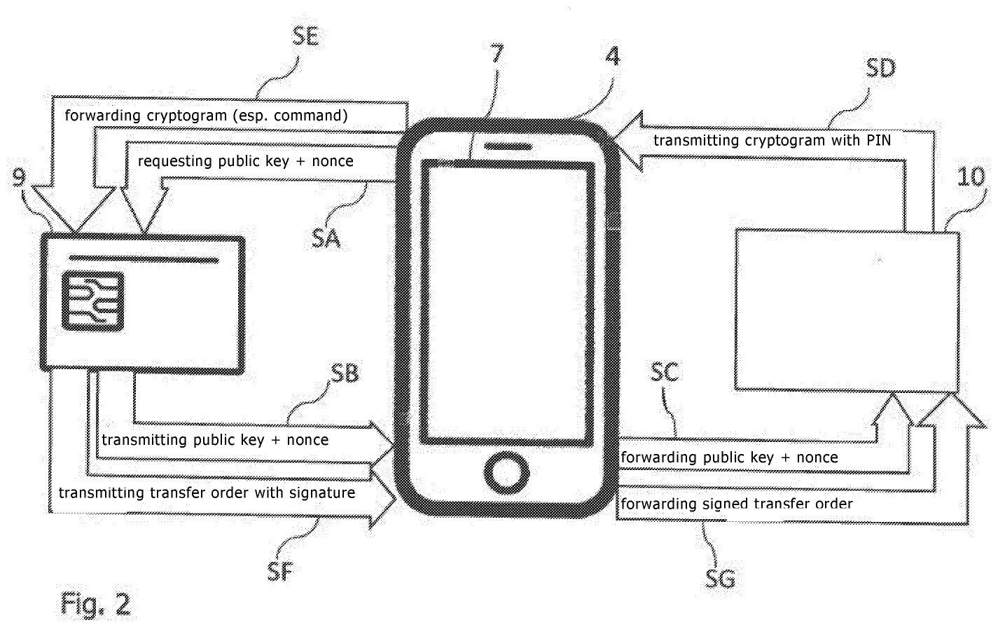

FIG. 2 a further schematic depiction of the inventive arrangement, and

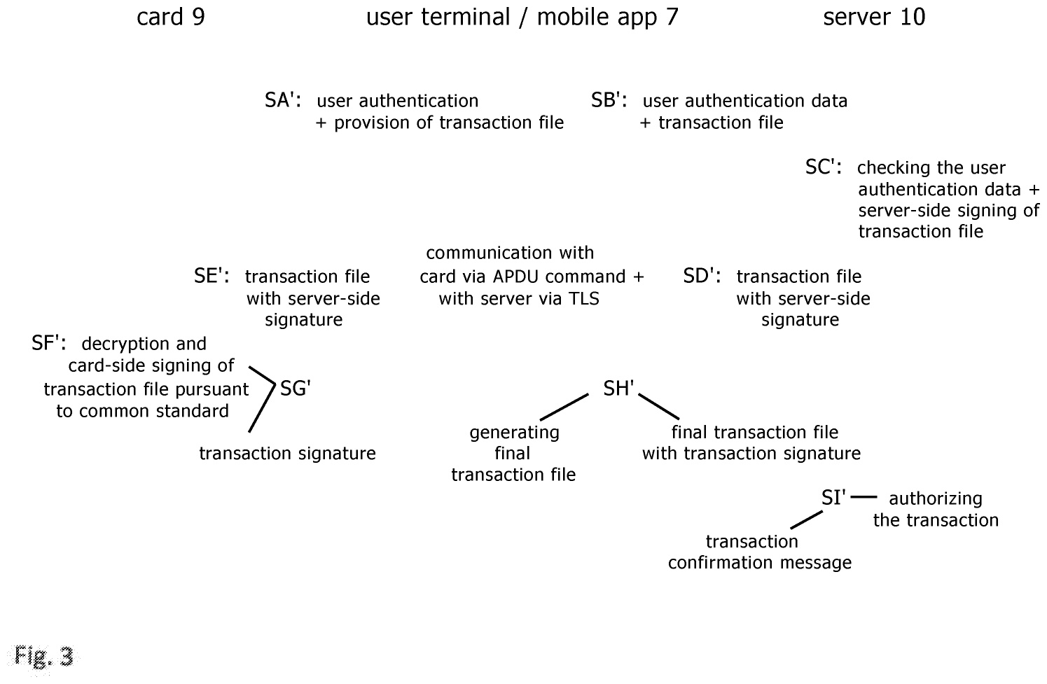

FIG. 3 a flow chart of a further example method according to the invention.

The invention solves the object by a method for authorizing and executing a transaction which comprises the following steps in one advantageous implementation and simplified formulation in accordance with FIG. 1:
displaying initial transaction data 3 on a website 2, controlled by a plug-in software module 2a, on the display screen of a computer 1 used by a customer in making an online purchase;
automatically acquiring the transaction data 3 to generate an initial transaction file 5 via a smartphone 4 of the user and displaying the initial transaction file 5 thereon;
processing the initial transaction file 5 on the smartphone 4 so as to extract at least part of the transaction data and generate a (new) transaction file 6 via a mobile app 7 installed on the smartphone 4,
requesting a PIN 8 of a debit or credit card 9 configured as a smart card 9 and equipped with NFC-data transmission means from an online banking server (trusted server) 10 via the smartphone 4,
transmitting the PIN 8 from the online banking server 10 to the smartphone 4;
transmitting the PIN 8 via NFC from the NFC card-equipped smartphone 4 to the smart card 9 wirelessly connected to same;
transmitting the transaction file 6 via NFC from the smartphone 4 to the smart card 9 wirelessly connected to same;
generating a digital signature (transaction signature) 12 for the transaction file 6 on the smart card 9 and outputting the transaction signature to the smartphone 4;
generating a final transaction file 13 which includes the transaction signature 12 in the mobile app 7,
transmitting the final transaction file 13 to the online banking server 10 via the mobile network,
generating a transaction confirmation message 14 after processing the final transaction file 13 to execute the transaction in the online banking server 10,
retrieving the transaction confirmation message 14 by a provider software;
receiving the transaction confirmation message 14 at a (not shown) provider receiver and visually and/or acoustically displaying the message on the provider website 2.

As FIG. 2 roughly depicts, checking the PIN can occur without any user assistance in a first alternative as follows:
The mobile app 7 requests a public key from the bank card 9 to encrypt the PIN assigned to the FinTS application on the card, the Puk_{PIN} and a single-use random number, generally called a nonce (number used once). The nonce serves the purpose of preventing replay attacks by a PIN cryptogram only being valid once, whereby supplementation and/or replacement by a timestamp would also be conceivable. The FinTS application on the card 9 is configured so as to store the random number generated as valid until the subsequent PIN check (step SA). The bank card provides same (step SB).
The mobile app 7 forwards the Puk_{PIN} and nonce to the online banking server 10 via a privacy and integrity-secured connection of the smartphone 4 (step SC).
The online banking server 10 creates a data packet of plain text-PIN, nonce and further random numbers if applicable as padding to obtain the PuK_{PIN} key length. This is encrypted with the PuK_{PIN} and transmitted as K_{PIN} cryptogram to the mobile app 7 (step SD).
The mobile app 7 transmit K_{PIN} to the card 9—by means of a command which, similar to the PIN_VERIFY( ) EMV command, prompts the card to check both the accuracy of the encrypted PIN as well as the nonce in the K_{PIN} cryptogram (step SE).
The mobile app 7 allows the bank card 9 to sign the payment transfer and the bank card 9 transmits the payment transfer with signature (step SF). The mobile app sends the signed payment transfer to the online banking server 10 (step SG).

FIG. 3 shows a possible configuration of an inventive method for the case in which the authorization data set does not consist of the card PIN but rather the transaction file. The basis is the arrangement shown in FIG. 1.
The mobile app 7 displays the transaction data to the user, requesting the user to confirm the transaction within the framework of a fingerprint or PIN input (act of will), and then generates the transaction file 6 to be subsequently signed by the card 9 from the transaction data (step SA′).
The mobile app 7 establishes a mutually authenticated encrypted TLS communication channel with the online banking server 10 and sends the user authentication data over same to the online banking server 10; i.e. the result of the smartphone's internal fingerprint comparison or PIN input as saved once in the online banking server 10 (step SB′).
The online banking server 10 checks the user authentication data and, given a positive result, encrypts the transaction file with a symmetrical key, which is also stored on card 9, or signs the transaction file with a private key, the corresponding public key to which is stored on card 9 (step SC).
The online banking server 10 sends the encrypted or signed transaction file to the mobile app 7 (step SD′).
The mobile app 7 packs the transaction file into an APDU command without decrypting or processing it and forwards it to the card 9 via NFC (step SE′).
The card 9 receives the APDU command and decrypts the transaction file if the online banking server 10 uses symmetrical keys or respectively checks the transaction file signature if the online banking server 10 uses asymmetrical keys (step SP).
The card 9 generates a digital signature or cryptogram respectively, e.g. Message Authentication Code (MAC), for the transaction file pursuant to the common standards and transmits same in APDU format to the mobile app 7 (step SG′).
Lastly, a final transaction file, which includes the transaction signature, is generated in the mobile app 7 and transmitted to the online banking server 10 (step SH′). After transaction authorization, the online banking server 10 transmits in step j) a corresponding confirmation to the mobile app 7 (step SI′).

When the method according to the invention is embedded into a mobile commerce process, the use of a computer 1 is dispensed with and inventive step a), in which the transaction data 3 is graphically displayed on the website 2, is visualized as e.g. QR code. Step b) changes in this case to the effect of the smartphone 4 no longer needing to scan in the transaction file 3 but it instead being rendered as part of a data communication from the web server to a browser on the smartphone.

If the online merchant does not wish to make the inventive payment method conspicuously selectable for all buyers, because only some of the buyers are equipped with smartphones 4 and smart cards 9 according to the invention, the mobile commerce variant of the inventive payment method can also be integrated into an already established payment system.

In this case, the homepage of the established payment system can include a JavaScript which is loaded into the smartphone browser and detects the user-agent string there and, if it indicates an Android-based Chrome browser, directs the browser to a new web page where the user needs to confirm the further process by pressing a menu button. The new web page thereafter returns a URL to the Chrome browser which is configured to either allow an inventive mobile app 7 installed on the smartphone to open by Android Intent Call or, if this is not possible, redirect to the homepage of the established payment system.

The established payment process is likewise used when the JavaScript of the homepage concludes, based on the detected user-agent string, that the connected browser is not an Android-based Chrome browser.

The embodiment of the invention is not limited to these examples but is rather also possible in a plurality of variations which lie within the scope of skill in the art.

1. A method for authorizing online payments, the method including:
transmitting transaction data using a mobile network or WLAN comprising the steps:
a) providing a transaction file on a user terminal in the mobile network or WLAN,
b) establishing a bidirectional data connection between the user terminal and an online banking server;
c1) requesting an authorization data set, in particular a PIN, of a debit or credit card configured as an internal smart card component within the user terminal or as a smart card and equipped with means for wireless near-field data transmission, from the online banking server,
c2) transmitting the authorization data set from the online banking server to the user terminal, the user terminal receiving same;
d1) establishing a wireless near-field data transmission link between the user terminal and the smart card; and
d2) transmitting the authorization data set from the user terminal to the smart card via the near-field data transmission link, or
d3) internally transferring the authorization data set to the smart card component in the user terminal,
e) checking the authorization data set by means of a processor of the smart card or smart card component based on comparison data stored thereon and, if correct, outputting a correctness confirmation message to the user terminal or internally within the user terminal,
f1) transmitting the transaction file from the user terminal to the smart card via the near-field data transmission link, or
f2) internally transferring the transaction file to the smart card component in the user terminal,
g) generating a digital signature for the transaction file on the smart card or smart card component and outputting the transaction signature to the user terminal or internally within the user terminal,
h) generating a final transaction file which includes the transaction signature in the user terminal,
i) transmitting the final transaction file from the user terminal to the online banking server via mobile network or WLAN, and
j) retrieving or receiving a transaction confirmation message from the online banking server on the user terminal.

2. A method for authorizing online payments, the method including: transmitting transaction data using a mobile network or WLAN comprising the steps:
a) providing a transaction file on a user terminal in the mobile network or WLAN,
b) establishing a bidirectional data connection between the user terminal and an online banking server;
c1′) transmitting an authorization data set, in particular the transaction file, to the online banking server,
c2′) signing the authorization data set on the online banking server with a private key which matches a public key stored on a smart card wirelessly connected to the user terminal or a smart card component integrated into the user terminal,
c3′) transmitting the signed authorization data set from the online banking server to the user terminal, the user terminal receiving same, and
d1) establishing a wireless near-field data transmission link between the user terminal and the smart card; and
d2) transmitting the authorization data set from the user terminal to the smart card via the near-field data transmission link, or
d3) internally transferring the authorization data set to the smart card component in the user terminal,
e′) checking the signature for the authorization data set, in particular the transaction file, by means of a processor of the smart card or smart card component using a key stored thereon,
g) generating a digital signature, potentially also as a cryptogram, for the transaction file on the smart card or smart card component and outputting the transaction signature to the user terminal or internally within the user terminal,
h) generating a final transaction file which includes the transaction signature in the user terminal,
i) transmitting the final transaction file from the user terminal to the online banking server via mobile network or WLAN, and
j) retrieving or receiving a transaction confirmation message from the online banking server on the user terminal.

3. The method according to claim 2, wherein the following steps are modified: step c2′) into step c2″) by the server not signing the authorization data set but rather encrypting it with a symmetrical key stored on the smart card or smart card component,
step e′) into step e″) by the smart card or smart card component not checking any signature for the authorization data set but rather encrypting the authorization data set with a suitable symmetrical key.

4. The method according to claim 1, wherein the authorization data set is transmitted encrypted end-to-end from the online banking server to the smart card in steps c) and d1) or d2) and the user terminal is only used as a transmission station which neither encrypts nor processes the authorization data set.

5. The method according to claim 1, wherein step a) comprises the following sub-steps:
a0) transmitting initial transaction data from a web server to a display unit connected to a data network via said data network, and
a01) local visual and/or acoustic displaying of the initial transaction data thereon, particularly visually displaying as bar code or QR code on a provider website or
a02) forwarding the initial transaction data via Google or Apple Push Notification service to the user terminal,
a11) receiving the display and generating an initial transaction file in the user terminal or
a12) receiving the display and generating an initial transaction file in a receiver device and thereafter transmitting same to the user terminal via wireless close-range data transmission, and
a2) processing the initial transaction file on the user terminal to extract at least some of the transaction data.

6. The method according to claim 1, wherein step a) comprises the following sub-steps:
a0′) transmitting initial transaction data from a web server to the user terminal via the data network and mobile network or WLAN and generating an initial transaction file in the user terminal, and
a1′) processing the initial transaction file on the user terminal so as to extract at least some of the transaction data.

7. The method according to claim 1, wherein a mobile app installed on the user terminal is authenticated to the online banking server in step b) by means of a private key which is in particular fragmented pursuant to the white-box cryptography principle and stored in distributed fashion by the program code of the mobile app.

8. The method according to claim 7, wherein the mobile app is uniquely assigned an NFC card of wireless near-field data transmission during installation on the user terminal and this assignment is stored in the online banking server.

9. The method according to claim 7, wherein the mobile app is authenticated to the online banking server by a public key procedure and/or the mobile app and transaction server communication is subject to encryption.

10. The method according to claim 1, wherein a step of user biometric authentication is additionally performed on the user terminal, in particular by means of a fingerprint sensor.

11. The method according to claim 2, wherein the following steps are augmented:
step a) into a step a′) by user authentication data needing to be collected prior to the provision of a transaction file, in particular a fingerprint comparison result or a PIN to be input by the user as stored in the online banking server,
step c1′) into a step c1″) by the user authentication data as collected being transmitted to the online banking server additionally to the authorization data set, in particular the transaction file, and
step c2′) into a step c2″) by the user authentication data being checked prior to the signature or encrypting of the transaction file respectively.

12. The method according to claim 1, wherein the near-field data transmission ensues pursuant to the near-field communication (NFC) protocol and the EMV standard for chip-based payment cards.

13. An arrangement for authorizing online payments, for implementing the method according to claim 1, wherein the arrangement comprises:
a user terminal connected to a mobile network or WLAN comprising means for providing a transaction file and means for wireless near-field data transmission,
a debit or credit card configured as an internal smart card component within the user terminal or as a smart card having means for wireless near-field data transmission the smart card or smart card component having a processor for checking received data comprising an authorization data set of the debit or credit card based on comparison data stored in the debit or credit card and, if correct, outputting a correctness confirmation message and generating and outputting a signature for the transaction file,
an online banking server having receiving means for receiving the request of an authorization data set via the mobile network or WLAN and a data network and transmitting means for the encrypted transmitting of the requested authorization data set to the user terminal, and
a mobile app installed on the user terminal for controlling, generating and processing the transaction file as well as for requesting and receiving the authorization data set, transmitting the transaction file and linked authorization data set from the user terminal to the smart card wirelessly connected to same and receiving the correctness confirmation message from same, generating a final transaction file in the user terminal based on the correctness confirmation message and card-side generated signature for the transaction file and transmitting the final transaction file from the user terminal to the online banking server, wherein the online banking server is configured to receive the final transaction file and generate and send an authorization confirmation message.

14. The arrangement according to claim 13, wherein the online banking server comprises transmitting means to transmit the requested authorization data set encrypted end-to-end, wherein it uses the user terminal as the receiving station of the near-field data transmission and as the transmitting station of the mobile network or WLAN.

15. The arrangement according to claim 13, wherein the means for near-field data transmission is configured pursuant to the near-field communication (NFC) protocol and the EMV standard for chip-based payment cards and comprises an NFC-enabled debit or credit card assigned to the user terminal.

16. The arrangement according to claim 13, wherein the user terminal comprises a device key to authenticate in particular a private key in terms of a public key infrastructure (PKI) at least with respect to an app loading system and with respect to the online banking server.

17. The arrangement according to claim 13, wherein the user terminal comprises a biometric sensor for detecting biometric data of a user, in particular a fingerprint sensor, and the mobile app for processing a biometric data set is formed by a biometric sensor.
